(19) United States
(12) Patent Application Publication
(10) Pub. No.: US 2008/0107578 A1
(43) Pub. Date: May 8, 2008

(54) THE RECOVERY OF ALUMINA TRIHYDRATE DURING THE BAYER PROCESS USING A WATER CONTINUOUS POLYMER

(76) Inventors: Jing Wang, Naperville, IL (US); Kevin L. O'Brien, Saint Charles, IL (US); Michael G. Strominger, Naperville, IL (US); David C. Davis, Naperville, IL (US)

Correspondence Address: William J. Maheras;Patent and Licensing Department, Nalco Company, 1601 West Diehl Road, Naperville, IL, 60563-1198, US

(21) Appl. No.: 11/557,341

(22) Filed: Nov. 7, 2006

(51) Int. Cl. C01F 1/00

(52) U.S. Cl. 423/122

(57) ABSTRACT

A method for increasing the floccule size and volume of alumina trihydrate during the Bayer processing of bauxite ore using a flocculant in conjunction with a water continuous polymer. The addition of the flocculant and the water continuous polymer to the alumina trihydrate slurry following the security filtration and settling producing trihydrate that is put through the calcination process to produce purified alumina or used as seed for the precipitation process.

### TECHNICAL FIELD

The invention relates to a method for increasing the flocculation of alumina trihydrate in the Bayer process for the production of alumina from bauxite ore. The invention concerns using a flocculant and a water continuous polymer to increase floccule size and volume, which in turn increases the settling rate of alumina trihydrate.

### BACKGROUND OF THE INVENTION

In the typical Bayer process for the production of alumina trihydrate, bauxite ore is pulverized, slurried in water, and then digested with caustic at elevated temperatures and pressures. The caustic solution dissolves oxides of aluminum, forming an aqueous sodium aluminate solution. The caustic-insoluble constituents of bauxite ore are then separated from the aqueous phase containing the dissolved sodium aluminate. Solid alumina trihydrate product is precipitated out of the solution and collected as product.

The Bayer process is constantly evolving and the specific techniques employed in industry for the various steps of the process not only vary from plant to plant, but also are often held as trade secrets. As a more detailed, but not comprehensive, example of a Bayer process, the pulverized bauxite ore may be fed to a slurry mixer where an aqueous slurry is prepared. The slurry makeup water is typically spent liquor (described below) and added caustic. This bauxite ore slurry is then diluted and passed through a digester or a series of digesters where about 98% of the total available alumina is released from the ore as caustic-soluble sodium aluminate. The digested slurry is then cooled, for instance to about 230° F., employing a series of flash tanks wherein heat and condensate are recovered. The aluminate liquor leaving the flashing operation often contains from about 1 to about 20 weight percent solids, which solids consist of the insoluble residue that remains after, or is precipitated during, digestion.

The clarified sodium aluminate liquor is usually seeded with alumina trihydrate crystals to induce precipitation of alumina in the form of alumina trihydrate, Al(OH)₃. The alumina trihydrate particles or crystals are then separated from the concentrated caustic liquor, and the remaining liquid phase, the spent liquor, is returned to the initial digestion step and employed as a digestant after reconstitution with caustic.

The clarified sodium aluminate liquor (which may be the overflow from primary settler or the supernatant), also referred to as “green liquor”, is a hot caustic liquor, generally containing the highest values of dissolved sodium aluminate. Sodium aluminate-containing liquor is kept at elevated temperatures during the beneficiation steps so as to retain its high values of dissolved sodium aluminate. It is charged to a suitable precipitation tank, or series of precipitation tanks, and almost always seeded with recirculated fine particle alumina trihydrate crystals. In the precipitation tank(s) it is cooled under agitation to induce the precipitation of alumina from solution as alumina trihydrate. The fine particle alumina trihydrate crystal seeds act as crystal nucleation sites for this precipitation process.

Alumina trihydrate crystal formation (the nucleation and growth of alumina trihydrate crystals), and the precipitation and collection thereof, are critical steps in the economic recovery of aluminum values by the Bayer process. Bayer process operators strive to optimize their crystal formation and precipitation methods so as to produce the greatest possible product yield from the Bayer process while producing crystals of a given particle size distribution. A relatively large particle size is beneficial to subsequent processing steps required to recover aluminum metal. Undersized alumina trihydrate crystals, or fines, generally are not used in the production of aluminum metal, but instead are recycled for use as fine particle alumina trihydrate crystal seed. If too much of the overall product yield is formed as fines, the production rate of alumina trihydrate crystals usable for aluminum metal production is diminished, the seed/product production balance is skewed, and the fraction of the overall product yield that is of sufficient particle size to be used for aluminum metal production routinely will still suffer from a less than optimum particle size distribution for the electrolytic production of aluminum metal.

After formation, the alumina trihydrate particles or crystals are separated from the concentrated caustic liquor, and the remaining liquid phase (the spent liquor) is returned to the initial digestion step and employed as a digestant after reconstitution with caustic. This separation or recovery of alumina trihydrate as product in the Bayer process, or for use as precipitation seed, is generally achieved by settling and/or filtration. Coarse particles settle easily, but fine particles settle slowly and to some extent are lost product or, if recovered by filtration, blind the filters. Typical plants will use two or three steps of settling which classify the trihydrate particles into product and seed. The overflow of the last classification stage is typically referred to as spent liquor. The spent liquor will go through heat exchangers and evaporation and eventually be used back in digestion. Therefore, it is important to achieve the lowest possible concentration of solids in the overflow of the last stage of classification to maximize the efficiency of the process. Conventional technology employs the addition of synthetic water soluble polyacrylate flocculants and/or dextran flocculants to improve the settling characteristics of the alumina trihydrate particles in the classification process (Moody et al Patent #5041269) and reduce the amount of solids in the spent liquor.

In the present invention it is discovered the use of flocculants in combination with synthetic water continuous polymers increases the effectiveness of the Bayer Process and increases the final production of trihydrate particles when used with bauxite containing organics. The bauxite must have a level of at least 10 g/l of organics to be considered containing organics. Synthetic water continuous polymers are high molecular weight poly(methyl acrylate/acrylic acid), poly (methyl acrylate, poly(vinyl acetate/acrylic acid/methyl acrylate) and a combination of high molecular weight poly(methyl acrylate/acrylic acid) with a lower molecular weight poly(methyl acrylate/acrylic acid) as described in U.S. patent applications Selvarajan et al. U.S. Pat. No. 6,086,771, Selvarajan et al. U.S. Pat. No. 6,036,869 and Sommese U.S. Pat. No. 5 405,898

### SUMMARY

It is the advantage of the invention to increase the floccule size of the fine alumina trihydrate formed during the Bayer Process.

It is another advantage of the invention to increase the amount of the crystals of alumina trihydrate captured during the Bayer process.

It is a further advantage of the invention to provide an improvement over the use of a dextran flocculant alone or in conjunction with conventional water soluble polyacrylate flocculants in the settling of alumina trihydrate in the Bayer process.

### DETAILED DESCRIPTION OF INVENTION

A process for extracting alumina trihydrate comprising the digestion of pretreated bauxite ore in an alkaline liquor to produce a slurry of red mud solids and aluminate dissolved in the alkaline liquor then decanting from the red mud solids to produce the decanting liquor; the passing of said decanting liquor through security filtration to remove all solids, precipitation and produce a slurry containing alumina trihydrate solids which then are settled with the addition of a flocculant and a water continuous polymer producing trihydrate that is put through the calcination process to produce purified alumina or used as seed for the precipitation process.

The preferred flocculent in the process is a polysaccharide and the preferred polysaccharide is dextran. The water continuous polymer is added to the Bayer process in the range of 0.13 to 10 ppm actives and the flocculant is added in the range of 0.1 to 5 ppm actives. The most preferred dosage for the water continuous polymer is 0.7 to 5 ppm actives and the most preferred dosage for the flocculant is 0.2 to 3 ppm actives.

The flocculant and the water continuous polymer can be added during the settling of the hydrate stage of the Bayer process in a sequential order rather than simultaneously. The water continuous polymer may be added first followed by the flocculant or in the reverse order depending on the preference of the processing facility or the type of bauxite ore being processed.

Table of Product Descriptions

| | |
|---|---|
| A | Dextran |
| B | Water Continuous Flocculant |
| C | Polyacrylate Latex Flocculant (High Molecular Weigh, 100% Charge) |
| D | Polyacrylate Latex Flocculant (Low Molecular Weight, 100% |
| | Charge) |
| E | Polyacrylate Latex Flocculant (High Molecular Weigh, 70% Charge) |
| F | Polacrylate/MASA based Latex Floccuant (90% Acrylate/10% 4- |
| | methacrylamido salicylic acid (MASA)) |
| G | Polacrylate/MASA based Latex Floccuant (96% Acrylate/3.5% 4- |
| | methacrylamido salicylic acid (MASA)/0.5% Acrylamide) |

Note:
All percentages reported are molar basis.

### EXAMPLE 1

200 ml of a bauxite liquor comprising 50 g/l aluminum trihydrate solids and 233.6 g/l alkali was maintained at 60° C. Focused beam reflectance measurement (FBRM) was conducted to monitor the aggregate size of the aluminum trihydrate particles (proportional to the chord length) in the above liquor. Typical flocculant products Product C, Product D, Product E, Product F, Product G, when used in the tested dosage range (0.3-1 ppm), did not increase the aggregate size of the floes as dosage increased. With the water-continuous polymer (Product B), as more polymer was added, larger aggregates formed.

TABLE 1
Change of aluminum trihydrate chord length with addition of
synthetic polymers following dextran (Product A).

| | | ppm | delta chord |
|---|---|---|---|
| | ppm A | polymer | length, |
| Product | (actives) | (actives) | microns |
| A + B | 0.65 | 0.30 | 24.434 |
| A + B | 0.65 | 0.61 | 33.789 |
| A + B | 0.65 | 0.91 | 36.782 |
| A + C | 0.65 | 0.32 | 25.596 |
| A + C | 0.65 | 0.64 | 23.066 |
| A + C | 0.65 | 0.96 | 23.125 |
| A + D | 0.65 | 0.32 | 15.653 |
| A + D | 0.65 | 0.64 | 14.47 |
| A + D | 0.65 | 1.06 | 16.614 |
| A + E | 0.65 | 0.35 | 20.599 |
| A + E | 0.65 | 0.71 | 19.129 |
| A + E | 0.65 | 1.06 | 18.941 |
| A + F | 0.65 | 0.35 | 12.107 |
| A + F | 0.65 | 0.62 | 11.853 |
| A + F | 0.65 | 1.06 | 12.748 |
| A + G | 0.65 | 0.31 | 16.511 |
| A + G | 0.65 | 0.62 | 17.904 |
| A + G | 0.65 | 1.03 | 17.206 |

### EXAMPLE 2

200 ml of a Bayer liquor comprising 50 g/l aluminum trihydrate solids and 233.6 g/l alkali was maintained at 60° C. As shown in Table 2, dextran (Product A) and various synthetic water continuous polymer dosages (Product B) were used in the form of either single component or blends in the tests. Dosages of components as indicated in the table were added in a certain sequence and mixed. The samples were left to settle for 1 minute. The overflow solids was measured by filtering a 60 ml aliquot through a pre-weighed No. 934 AH filter paper, wash with hot deionized water, drying the filter paper and contents at 100° C. and reweighing. In the table below 5676-5-A contains 32% Product A, 68% Product B actives, 5676-5-C contains 13% Product A, 87% Product B actives, {A/B} means that the two components where added sequentially with Product A first, and then Product B and {B/A} also means that the two components where added sequentially with Product B first, and then Product A

TABLE 2
Settling tests of seeds with addition of A and Product B (dry seed
and liquor, 60° C., 1 minute settling)

| | | | overflow | |
|---|---|---|---|---|
| | | | solids | % |
| Product | ppm A | ppm B | (g/L) | Reduction |
| A | 0.175 | 0.00 | 19.80 | 0.25 |
| A | 0.35 | 0.00 | 12.28 | 38.12 |
| A | 0.7 | 0.00 | 11.12 | 40.02 |
| A | 1.05 | 0.00 | 9.75 | 47.39 |
| B | 0.00 | 0.38 | 6.87 | 65.41 |
| B | 0.00 | 0.60 | 7.25 | 60.88 |
| B | 0.00 | 0.75 | 6.08 | 69.35 |
| B | 0.00 | 1.13 | 7.53 | 59.35 |
| B | 0.00 | 1.50 | 8.57 | 56.84 |
| 5676-5-A | 0.105 | 0.23 | 7.00 | 62.23 |
| 5676-5-A | 0.175 | 0.38 | 5.62 | 71.70 |
| 5676-5-A | 0.35 | 0.75 | 10.03 | 49.45 |
| 5676-5-A | 0.7 | 1.50 | 9.02 | 51.35 |
| Control | 0.00 | 0.00 | 19.85 | 0.00 |
| 5676-5-C | 0.116 | 0.75 | 8.67 | 53.24 |
| 5676-5-C | 0.175 | 1.125 | 7.40 | 60.07 |
| 5676-5-C | 0.35 | 2.25 | 9.67 | 51.30 |
| A/B | 0.175 | 0.375 | 6.65 | 64.12 |
| A/B | 0.35 | 0.75 | 7.60 | 58.99 |
| A/B | 0.70 | 1.50 | 7.95 | 57.10 |
| B/A | 0.175 | 0.375 | 9.08 | 50.99 |
| B/A | 0.35 | 0.75 | 8.83 | 52.34 |
| B/A | 0.70 | 1.50 | 9.78 | 47.21 |

### EXAMPLE 3

The secondary overflow was collected in a stainless steel batch can and mixed well before use. Each 250 ml Nalgene bottle was filled with 200 ml of overflow and placed in the water bath (60° C.) before testing. In each test, one bottle was removed from the bath and shaken for 30 s. Then a certain amount of sample polymer flocculant as indicated in Table 3 was added to the bottle. After 60 s of shaking, the slurry was poured into a 250 ml cylinder, which was placed in a water bath (60° C.). After 3 minutes of settling, 60 ml of supernatant was sampled from the top of the cylinder using a 60 ml syringe and filtered through the vacuum filtration system using pre-weighed filter paper. The filter paper was then dried in an oven at 100° C. overnight. The final weight of this filter paper was collected the next day and converted to the solids in the overflow. Again {A/B} means that the two components where added sequentially with Product A first, and then Product B and {B/A} also means that the two components where added sequentially with Product B first, and then Product A.

TABLE 3
Hydrate settling tests of seed secondary overflow with step-wise
addition of Product A and Product B (60° C., 3 minutes settling)

| | | ppm | overflow | % |
|---|---|---|---|---|
| Product | ppm A | Product B | solids (g/L) | Reduction |
| A | 0.175 | 0.000 | 25.15 | 21.05 |
| A | 0.350 | 0.000 | 16.89 | 46.99 |
| A | 0.700 | 0.000 | 13.33 | 58.16 |
| A/B | 0.175 | 0.375 | 18.03 | 43.40 |
| A/B | 0.350 | 0.750 | 11.37 | 64.31 |
| A/B | 0.700 | 1.500 | 7.26 | 77.20 |
| A | 0.700 | 0.000 | 6.77 | 66.44 |
| A/B | 0.700 | 1.500 | 4.30 | 78.67 |
| A/B | 1.050 | 2.250 | 4.52 | 77.60 |
| A/B | 1.400 | 3.000 | 3.55 | 82.39 |
| A | 1.050 | 0.000 | 4.87 | 75.86 |
| A | 1.400 | 0.000 | 5.23 | 74.04 |

In the tests, the flocculation efficiency of the combination of Product A and the Product B was tested at various polymer dosages. As shown in Table 3, the addition of Product B following Product A does improve the flocculation performance of Product A within all tested dosage range. However, the improvement extent decreased as the Product A dosage increased.

### EXAMPLE 4

The secondary overflow was collected in a stainless steel batch can and mixed well before use. Each 250 ml Nalgene bottle was filled with 200 ml of overflow and placed in the water bath (60° C.) before testing. In each test, one bottle was removed from the bath and shaken for 30 s. Then a certain amount of sample polymer flocculants (Product A and Product B) was added sequentially to the bottle as indicated in Table 3. After 60 s of shaking, the slurry was poured into a 250 ml cylinder which was placed in a water bath (60° C.). After 3 minutes of settling, 60 ml of supernatant was sampled from the top of the cylinder using a 60 ml syringe and filtered through the vacuum filtration system using pre-weighed filter paper. The filter paper was then dried in the oven at 100° C. overnight. The final weight of filter papers was collected the next day and converted to the solids in the overflow.

TABLE 4
Effect of addition sequence of Product A and Product B on
their flocculation efficiency (60° C., 3 minutes settling)

| | | | overflow | % |
|---|---|---|---|---|
| Product | ppm A | ppm B | solids (g/L) | Reduction |
| A/B | 0.700 | 1.500 | 4.30 | 78.67 |
| A/B | 1.050 | 2.250 | 4.52 | 77.60 |
| A/B | 1.400 | 3.000 | 3.55 | 82.39 |
| B/A | 0.700 | 1.500 | 4.87 | 75.86 |
| B/A | 1.050 | 2.250 | 5.38 | 73.30 |
| B/A | 1.400 | 3.000 | 4.65 | 76.94 |

### EXAMPLE 5

Focused beam reflectance measurement (FBRM) was conducted to monitor the aggregate size of the aluminum trihydrate floccule (proportional to the chord length) in the secondary overflow mentioned in Example 4. From the results shown in Table 5, the mean chord length of the overflow solids increased as product A was added followed by product B. This indicates that the combination of A and B do act as a more effective flocculant than A alone.

TABLE 5
Change of hydrate chord length with addition of synthetic
polymers following Product A (secondary overflow, 60° C.)

| | | | delta chord |
|---|---|---|---|
| | | | length, |
| Product | ppm A | ppm B | microns |
| A | 0.175 | 0.00 | 0.931 |
| A/B | 0.175 | 0.375 | 2.045 |
| A | 0.35 | 0.00 | 1.381 |
| A/B | 0.35 | 0.75 | 3.261 |
| A | 0.70 | 0.00 | 2.032 |
| A/B | 0.70 | 1.50 | 2.416 |

The foregoing may be better understood by reference to the following examples, which are intended to illustrate methods for carrying out the invention and are not intended to limit the scope of the invention.

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A process for extracting alumina trihydrate comprising: the digestion of pretreated bauxite ore in an alkaline liquor to produce a slurry of red mud solids and aluminate in suspension in the alkaline liquor then decanting the red mud solids from the alkaline liquor suspension to produce the decanting liquor; the passing of said decanting liquor through security filtration to remove all solids, precipitation and produce a slurry containing alumina trihydrate solids which then are settled with the addition of a flocculent and a water continuous polymer producing trihydrate that is put through the calcination process to produce purified alumina or used as seed for the precipitation process.

2. The process of claim 1 wherein the flocculant is a polysaccharide.

3. The process of claim 2 wherein the polysaccharide is dextran.

4. The process of claim 1 wherein 0.2 to 10 ppm actives of the water continuous polymer is added to the trihydrate classification.

5. The process of claim 4 wherein 0.1 to 5 ppm actives of the flocculant is added to the trihydrate classification.

6. The process of claim 1 wherein 0.7 to 5 ppm actives of the water continuous polymer is added to the trihydrate classification.

7. The process of claim 6 wherein 0.3 to 3 ppm actives of the flocculant is added to the trihydrate classification.

8. The process of claim 1 wherein the flocculant and the water continuous polymer are added sequentially.

9. The process of claim 8 wherein the flocculant is added first and followed by the addition of the water continuous polymer.

10. The process of claim 8 wherein the water continuous polymer is added first and followed by the addition of the flocculant.
